(19) United States
(12) Patent Application Publication
(10) Pub. No.: US 2025/0139447 A1
(43) Pub. Date: May 1, 2025

(54) DOMAIN-SPECIFIC PROMPT PROCESSING AND ANSWERING VIA LARGE LANGUAGE MODELS AND ARTIFICIAL INTELLIGENCE PLANNERS

(71) Applicant: Intuit, Inc., Mountain View, CA (US)

(72) Inventors: Sudhir AGARWAL, Palo Alto, CA (US); Esmé MANANDISE, Tallahassee, FL (US); Anu SREEPATHY, Sunnyvale, CA (US)

(21) Appl. No.: 18/496,496

(22) Filed: Oct. 27, 2023

(51) Int. Cl. G06N 3/09; G06F 9/54

(52) U.S. Cl. CPC G06N 3/09; G06F 9/54

(57) ABSTRACT

Certain aspects of the disclosure provide techniques for prompt processing. A method generally includes generating a representation of a prompt using a large language model (LLM), the representation comprising semantic features of the prompt, wherein the prompt requests a state change from an initial state to a desired goal state; generating a task description based on using the representation and a domain description; generating an execution plan for the task description, the execution plan comprising a sequence of steps used to transform the initial state to the desired goal state; executing the sequence of steps; and generating a natural language response to the prompt after completing the execution of the sequence of steps, wherein the natural language response is based on the information obtained or the desired goal state.

### BACKGROUND

### Field

Aspects of the present disclosure relate to domain-specific prompt processing and answering involving plan generation and execution.

### Description of Related Art

A prompt is a specific instruction and/or request, posed in natural language, given to a computer program and/or language model to perform a particular task and/or generate a specific output. In other words, a prompt is input (e.g., a question, a query, a command, etc.) that consists of terms or phrases spoken normally and/or entered as they might be spoken, without any special format and/or alteration of syntax. In some cases, prompts are generated through a text and/or voice interface.

In the context of natural language processing (NLP) and machine learning, prompts are often used to guide large language models (LLMs) in generating text. In particular, an LLM is a type of machine learning model that can perform a variety of NLP tasks, such as generating and classifying text, answering prompts in a conversational manner, and translating text from one language to another. NLP makes it possible for software to “understand” typical human speech or written content as input into an LLM-based system and respond to it by, in some cases, generating human-understandable responses through natural language generation (NLG).

A popular LLM, which has gained much recent attention, is “ChatGPT,” produced by OpenAI®. Generative pre-trained transformer (GPT) models, such as ChatGPT, are a specific type of LLM based on a transformer architecture (e.g., architecture that uses an encoder-decoder structure and does not rely on recurrence and/or convolutions to generate an output), pre-trained in a generative and unsupervised manner (e.g., it learns from data without being given explicit instructions on what to learn). GPT models analyze prompts and predict the best possible response based on their understanding of the language. In particular, the GPT models rely on the knowledge they gain after they are trained with, in some cases, billions or even trillions of parameters on massive datasets.

While LLMs, such as ChatGPT, represent a transformative force in many industries by enabling developers to build conversation-driven applications for prompt processing and answering, these models are not without limitation. For example, while a powerful tool, a general-purpose LLM is only as good as the underlying, publicly-available training data used to train the model. This presents a technical problem in cases where the knowledge artifacts necessary for accurately responding to a prompt are partly, or completely, internal to an organization. For example, a general-purpose LLM trained on publicly-available data, while vast, may not be able to respond, or may respond incorrectly, to a prompt requesting information about employee retention at a particular company for a previous year given this information is internal and confidential to the company (e.g., not publicly available, and thus not used to train the LLM).

### SUMMARY

Certain aspects provide a method of prompt processing. The method generally includes generating a representation of a prompt using a large language model (LLM), the representation comprising semantic features of the prompt, wherein the prompt requests a state change from an initial state to a desired goal state; generating a task description in planning domain definition language (PDDL) using the representation of the prompt and a domain description in the PDDL; generating an execution plan for the task description in the PDDL using an artificial intelligence (AI) planner the execution plan comprising a sequence of steps used to transform the initial state to the desired goal state; executing the sequence of steps of the execution plan; and generating a natural language response to the prompt after completing the execution of the sequence of steps, wherein the natural language response is based on the information obtained or the desired goal state.

Other aspects provide processing systems configured to perform the aforementioned method as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for answering prompts as planning problems.

FIG. 2 depicts an example workflow for answering prompts as planning problems.

FIG. 3 depicts an example task description and an example domain description in planning domain definition language.

FIG. 4 depicts an example method for prompt processing and answering.

FIG. 5 depicts an example processing system with which aspects of the present disclosure can be performed.

To facilitate understanding, identical reference numerals have been used, where

possible, to designate identical elements that are common to the drawings. It is contemplated that elements and features of one embodiment may be beneficially incorporated in other embodiments without further recitation.

### DETAILED DESCRIPTION

To address the shortcomings of general-purpose LLMs, some conventional approaches seek to combine and orchestrate LLM functionality with other sources of computation and/or knowledge. For example, some conventional approaches focus on using an LLM as a planner, by interfacing LLMs with organization-specific application programming interface(s) (API(s)) (e.g., mechanisms that enable at least two software components to communicate with each other using a set of definitions and protocols) and/or other tool(s). For instance, the LLM, acting as a planner, may be configured to perform similar functions as a planner used to solve classical artificial intelligence (AI) planning (also referred to as “classical planning” or simply “planning”) problems. Specifically, classical AI planning is the problem of finding a sequence of actions, e.g., an “execution plan” or simply a “plan,” for achieving a goal state from an initial state assuming that actions have deterministic effects.

For example, a prompt received by a planner may be (1) an information-seeking prompt requesting a state change from an initial state to a desired goal state, based on information retrieval of general and/or domain-specific data (e.g., desired goal state is the possession of information), (2) a task-oriented prompt requesting a state change from an initial state to a desired goal state, based on the completion of one or more tasks excluding information retrieval, or (3) a combination of both (e.g., requesting information retrieval and the performance of one or more other tasks). An information-seeking prompt may be a prompt requesting information about an organization's sales for the past month (e.g., “Please provide Organization's X's sales for January 2023”), a prompt requesting information about employee turnover statistics for an organization, a prompt requesting information about potential areas for organization development, and/or the like. On the other hand, task-oriented prompts may include prompts requesting to perform one or more tasks such as sending an email (e.g., “Send an event email to JaneDoe@gmail.com”), publishing a document, drafting an invoice and sending the invoice to a client, and/or the like. Further, an example information-seeking and task-oriented prompt may be “(e.g., “Send customer Jane Doe the invoice for 5 cakes for $125 on Sep. 30, 2023” given information about Jane Doe, her email, the cake, etc. need to be retrieved prior to performing other tasks (e.g., generating the invoice, sending the email, etc.) to reach the goal state.

LLMs as planners, used to solve classical AI planning problems, are responsible for (1) identifying a sequence of actions to reach a desired goal state indicated by an information seeking and/or task-oriented prompt and (2) orchestrating the execution of those actions. Specifically, by integrating an LLM with organization-specific API(s) and/or tool(s) such that the LLM is able to act as a planner, organizations can create a system where users of the organization can generate a prompts as a question, an instruction, a request, etc. in natural language. The LLM can interpret the prompt, interact with the necessary API(s) and/or tool(s) to retrieve data internal to the organization, manipulate the date, and/or perform other non-information retrieval tasks, and provide a response in a user-friendly manner.

Information-seeking and/or task-oriented prompts specific to an organization may require the use of multiple APIs and/or tools associated with the organization to resolve these prompts (e.g., reach the desired goal states). For example, information needed for responding to a user's information-seeking prompt may be stored in multiple databases created for the organization. Thus, the actions identified by an LLM to reach the desired goal state may include many API calls and/or database calls the different databases to retrieve the necessary/requested information. Similarly, with task-oriented prompts, not only are APIs and/or tools used to obtain information, but communication with other APIs and/or tools for performing various actions beyond information-retrieval are necessary to transition from an initial to a desired goal state set forth in the prompt.

For example, a user-submitted prompt may request to “Send an invoice to my client for the cake I baked last week and follow up weekly until my client has paid.” To resolve this prompt and reach the desired goal state indicated by the prompt (e.g., reach a state where the invoice has been sent and weekly reminders have been and/or are currently being carried out), multiple APIs may be needed to obtain information about whowho the client is, how much each ingredient for the cake cost to determine the total cost of the cake, the client's contact information, the client's preferences for communication, etc. Further, additional APIs may be needed to carry out tasks such as creating the invoice, creating a medium for transmitting the invoice (e.g., an email), sending reminder notifications, etc. As such, the LLM may need to interface with multiple APIs (and/or other tools) of the organization to resolve the single prompt. An LLM, however, may only be capable of interfacing with a limited number of specifically designed APIs and/or tools, and thus may not be able to resolve the user's prompt.

In particular, a technical problem associated with the use of existing LLMs configured to interface with APIs and/or tools is their inability to scale beyond, for example, a limited and specific set of APIs and/or tools. This is especially problematic where a standard business organization has hundreds or thousands of APIs, applications, and tools in place. For example, existing API/tool-augmented LLMs are limited to connect with a small number of specially designed tools/APIs. For instance, Toolformer™, an API/tool-augmented LLM, created by Meta Platforms, Inc. (doing business as Meta, and formerly named Facebook, Inc.) of Menlo Park, California, is trained to use only five different tools: a question-answering API, a Wikipedia search engine, a machine translation system, a calculator, and a calendar. As another example, Chameleon™ is an LLM-based planner that assembles a sequence of tools, among a set of fifteen total tools, to execute to generate a final response. Thus, the potential for connecting LLMs with a large number of APIs, and specifically a large number of domain-specific APIs and/or tools that may be constantly changing, remains under-explored and challenging. For example, while LLMs may be fine-tuned/trained to use multiple APIs and make specific API calls, fine-tuning/training such LLMs is a costly exercise. Additionally, when there are overlapping functionalities in the available APIs, the LLM might not always be able to select the correct API. The reason for this is that the LLM treats the API selection as a classification problem and tries to find a “close”/probabilistic match, which may not always be the correct choice. In other words, LLMs are based on probabilistic generation of output based on input. As a result, LLM-generated plans, especially in presence of a large number of APIs, are frequently wrong.

Another technical problem with using LLMs (e.g., where the LLM is configured to act as a planner) for solving domain-specific prompts, and more specifically domain-specific, task-oriented prompts, relates to the non-deterministic nature of such models. Specifically, LLMs predict the probability of a word or token given the context represented by a sample of words. The randomness in LLMs typically comes from the sampling methods used during text generation, such as top-k sampling and/or nucleus sampling. As a result, identical prompts may yield completely different responses in different requests. This non-determinism (i.e., this inconsistency in the responses generated in different requests with identical prompts) affects the accuracy, and thus reliability, of responses produced by these LLMs.

Embodiments described herein overcome the aforementioned technical problems and improve upon the state of the art by providing a system, combining an LLM with a standalone classical AI planner (simply referred to herein as a “planner”) and execution component, configured to process and answer prompts as planning problems. Specifically, the system processes and answers a prompt as a planning problem by (1) leveraging the language capabilities of the LLM to translate the prompt into a structured input for the planner, such as a task description in planning domain definition language (PDDL), (2) leveraging capabilities of the planner to generate an execution plan for the task description, where the execution plan involves the interaction with one or more domain-specific APIs and/or tools, (3) leveraging the execution component to carry out the execution plan to resolve the prompt, and (4) again leveraging the LLM to generate a human-understandable response, through NLG, in response to the prompt and based on the output of executing the execution plan.

The system described herein provides significant technical advantages over conventional approaches. In particular, having an LLM interact with a separate planner, as opposed to having an LLM act as a planner, to process and answer prompts as planning problems enables the system described herein to leverage the strengths specific to the LLM and the strengths specific to the planner.

For example, planners are tools proven to be useful in generating accurate and optimal plans for planning problems, and orchestrating the execution of these plans, for example, by leveraging a large number of domain-specific APIs and/or tools. In particular, planning requires understanding the domain description and reasoning over the available APIs and their functionality. Thus, by using a planner in combination with an LLM, the need to train an LLM to infer and interact with an appropriate sequence of API(s) and/or tool(s) needed for processing and answering a prompt is eliminated. Instead, the planner is leveraged for this functionality, and thus, the system is able to exploit a large number of domain-specific APIs and/or tools. Accordingly, the system described herein is an improved, scalable system that provides a prompt processing and answering solution for many domains (e.g., organizations), irrespective of the number of APIs and/or tools specific to those domains. In other words, the system may be capable of processing domain-specific information seeking prompts and domain-specific task-oriented prompts that may require the use of many APIs and/or tools.

Further, by configuring the system to use a planner, as opposed to an LLM acting as a planner in conventional implementations, actions carried out and/or information provided to the user in response to a user-submitted prompt may be a more accurate response to the prompt. In particular, a planner is known to be more deterministic in nature than an LLM. As such, the planner may behave in a more well-defined and predictable manner than the LLM when generating an execution plan, to therefore reduce inconsistency in execution plan generation for a same prompt. Additionally, the use of a standalone planner offers a solution that helps reduce, if not eliminate, the generation of erroneous and/or nonsensical execution plans (e.g., referred to as “hallucinations”) known to be more frequently generated when using LLMs as planners in conventional implementations. The reduction in inconsistency across similar prompt inputs, as well as the reduction (or elimination) of erroneous and/or nonsensical execution plans, leads to a more reliable and trustworthy system with prompt processing and answering functionality.

A planner, however, is generally designed to solve problems represented in a structured formal language, such as PDDL, and thus, may not be able to process a user-provided prompt in natural language. Thus, the system described herein leverages the language capabilities of LLMs to enable the system to comprehend, process, and respond to any prompt received as input. In particular, LLMs, such as GPTs, have the capability to process and understand vast amounts of data. As such, the system, including an LLM in combination with a planner, is more adept to solving a wider range of prompts, including unstructured and/or incomplete prompts, which is a current limitation of existing classical AI planning systems. Additionally, generating content and/or responses understandable to humans has historically been a challenge for machines that do not know the complexities and nuances of language. Thus, by incorporating the LLM, the system is able to provide human-understandable responses, based on the output of executing an execution plan generated by the planner of the system, to thereby provide a more positive interaction between a user which submitted the prompt and the system.

### Example System for Domain-Specific Prompt Processing and Answering

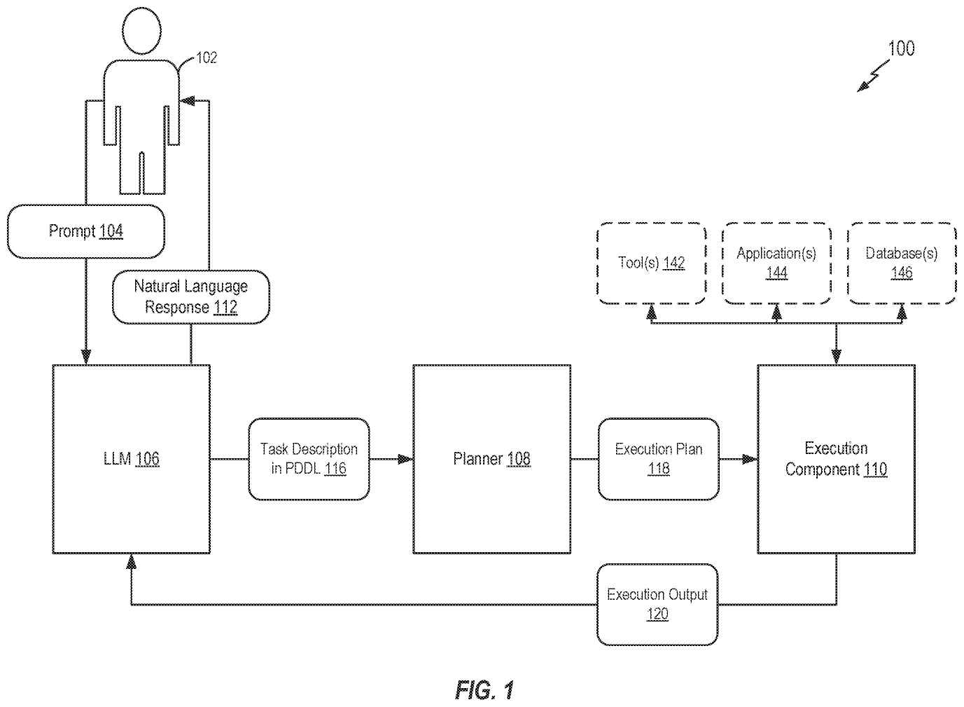

FIG. 1 depicts an example system 100 for answering prompts as planning problems. As illustrated, system 100 includes an LLM 106, a planner 108, and an execution component 110, which, together, are configured to resolve a prompt 104 (e.g., created by a user 102). In some examples described herein, resolution of prompt 104 involves achieving a desired goal state indicated via prompt 104, as well as generating a natural language response 112 based on the desired goal state achieved. As described above, a prompt and/or a natural language response consists of terms or phrases spoken normally and/or entered as they might be spoken, without any special format and/or alteration of syntax.

User 102 creates and submits prompt 104 to LLM 106. User 102 may submit prompt 104 through a text interface (e.g., a chat interface), a voice interface (e.g., as through a smart device), and/or the like. In some embodiments, prompt 104 requests a state change from an initial state to a desired goal state, where the desired goal state is achieved based on the completion of an information retrieval task (e.g., prompt 104 is an “information-seeking prompt”). For example, prompt 104 may be a question, such as “What was Company X's revenue for the past month compared to the budgeted revenue?” or a statement, such as “Please provide information about student licensing exam passage rates for the past five years.” In some embodiments, prompt 104 requests a state change from an initial state to a desired goal state, where the desired goal state is achieved based on the completion of one or more tasks, excluding information retrieval. For example, prompt 104 may be a narrative, such as “You control 2 robots. Each robot has a left gripper and a right gripper. There are two rooms and two balls. Robot 1 is in room 1. Robot 2 is in room 1. Ball 2 is in room 1. Ball 1 is in room 1. The robots' grippers are free. Your goal is to transport the balls to their destinations. Ball 1 should be in room 2. Ball 2 should be in room 2.” In this example, the initial state is that all balls and robots are in the room 1, and the robots' grippers are empty. Further, the desired goal state is that all balls are in room 2. In some embodiments, prompt 104 requests a state change from an initial state to a desired goal state, where the desired goal state is achieved based on the completion of multiple tasks including information retrieval. Further, prompt 104 may be related to a specific user or generic. For example, one prompt 104 may request a reminder is set to remind the user, who submitted prompt 104, about an upcoming town hall meeting, while another prompt 104 may request that a reminder is set to remind all users within an organization about the upcoming town hall meeting.

LLM 106 translates prompt 104 into a structured input for planner 108 (e.g., at runtime). For example, LLM 106 translates prompt 104 into a task description in PDDL 116.

PDDL is the standardized language for expressing planning tasks. PDDL divides the description of a planning task into (1) a domain description and (2) a task description. In the domain description, invariant rules of a world model, like object types, predicates, and possible actions that may be performed are described. The task description is based on the domain description and describes one concrete task/problem, specifying the objects which are part of the task/problem, an initial state, and the desired goal state that is to be fulfilled.

Everything modeled in PDDL is based on a set of objects (e.g., things in the world that are of interest), where each object belongs to a certain type; however, creating descriptions without any typing is possible in PDDL. Objects modeled in PDDL may be referred to as a constant or as a variable. When a constant is used, then it is clear exactly which specific object is being referred to. For instance, “yard” and “house” may be constants of type “location,” while “John” may be a constant of type “person.” In contrast, when arguing about any applicable object, variables are used, such as the expression “(?l1?l2—location)” which refers to two arbitrary objects of type “location.”

Predicates apply to a specific type of object, or to all objects. Predicates are either true or false at any point in a planning task. An example predicate is “(walls-built?s—site).” In this example, when the predicate is true for a given site, then it is assumed that the site has had walls built for it. When the predicate is false, it can be assumed that the said site does not have walls built for it yet.

Actions in the domain description define transformations in the state of the world (e.g., from a first state to a second state). This transformation is typically an action that could be performed in the execution of the planning problem, such as picking up an object, constructing something, and/or some other change.

LLM 106 is trained and thus configured to translate prompt 104 into a task description in PDDL by first generating a representation of prompt 104 that preserves semantic features of prompt 104. To generate this representation, LLM 106 may perform one or more NLP tasks, such as semantic analysis, entity extraction, concepts extraction, dependency parsing, topic analysis, and/or the like. For example, a set of curated LLM prompts focusing on carrying out one or more NLP tasks may be fed to LLM 106. The output of a prompt-based LLM call may become the input for a next prompt to LLM 106 to carry out these NLP task sand generate the representation. LLM 106 uses this representation to generate task description in PDDL 116.

Planner 108 uses task description in PDDL 116, as well as a pre-created domain description in PDDL (not shown in FIG. 1), to generate an execution plan 118. Execution plan 118 includes a sequence of steps used to transform the initial state to the desired goal state originally indicated in prompt 104. Steps defined in execution plan 118 may include interfacing with application(s) (e.g., via API(s), using tools, and/or accessing database(s)) specific to one or more organizations. Planner 108 provides execution plan 118 to execution component 110 to carry out the defined steps.

Execution component 110 execute steps of execution plan 118 in the order in which they are outlined in execution plan 118. Execution component 110 may make API call(s) to one or more applications 144, initiate database query (ies) for one or more databases 146, and/or trigger one or more functions (e.g., via one or more tools 142), as defined by execution plan 118. Essentially, execution component 110 executes the sequence of steps defined in execution plan 118 to transition to the desired goal state.

Execution of the sequence of steps defined in execution plan 118 results in an execution output 120. Execution output 120 may be a structural representation of the answer, and/or all the information needed to generate a final answer to prompt 104. For example, where the prompt is “Please provide information about student licensing exam passage rates for the past five years,” then the execution output may include an average and/or individual student licensing exam passage rates for years 2018, 2019, 2020, 2021, and 2022. As another example, where the prompt is “Please send an email reminder to Client Y about our upcoming meeting,” then execution output 120 may be a confirmation message that the requested email was sent.

LLM 106 uses execution output 120 to generate natural language response 112, which is then provided to user 102 in response to user 102 submitting prompt 104.

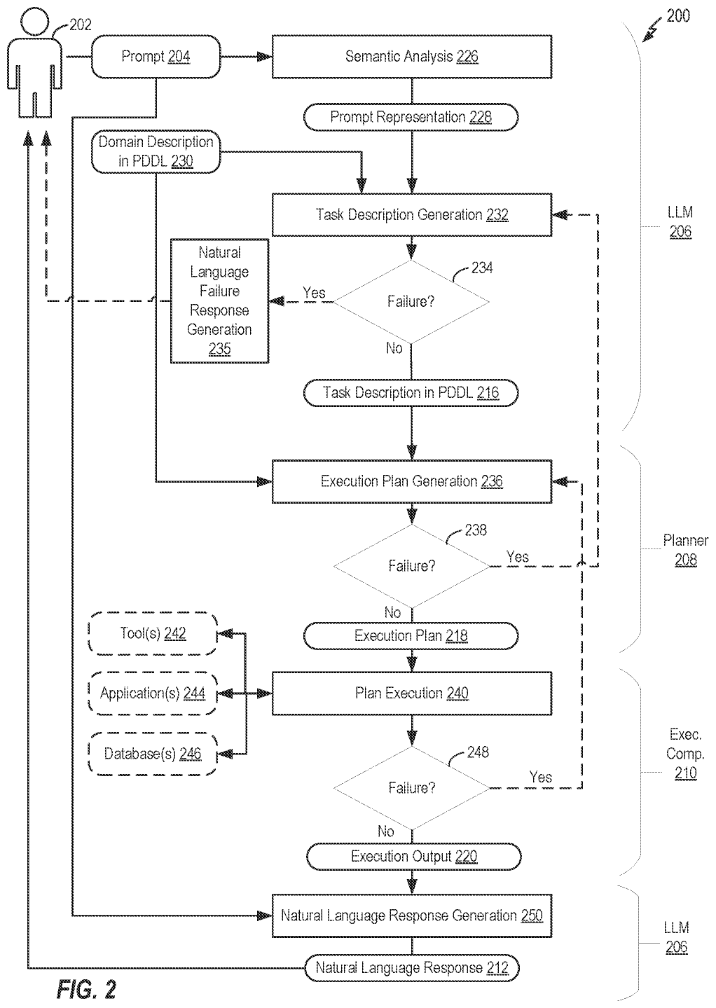

Additional details regarding steps performed by each of LLM 106, planner 108, and execution component 110 to answer a prompt as a planning problem are provided in FIG. 2.

Specifically, FIG. 2 depicts an example workflow 200 for processing and prompts as planning problems. Workflow 200 is performed by LLM 206, planner 208, and execution component 210, which may be examples of LLM 106, planner 108, and execution 110 depicted and described with respect to FIG. 1. Similarly, prompt 204, task description in PDDL 216, execution plan 218, execution output 220, and natural language response 212 shown in FIG. 2 as inputs and/or outputs for each of LLM 206, planner 208, and execution 210 may be examples of prompt 104, task description in PDDL 116, execution plan 118, execution output 120, and natural language response 112 depicted and described with respect to FIG. 1.

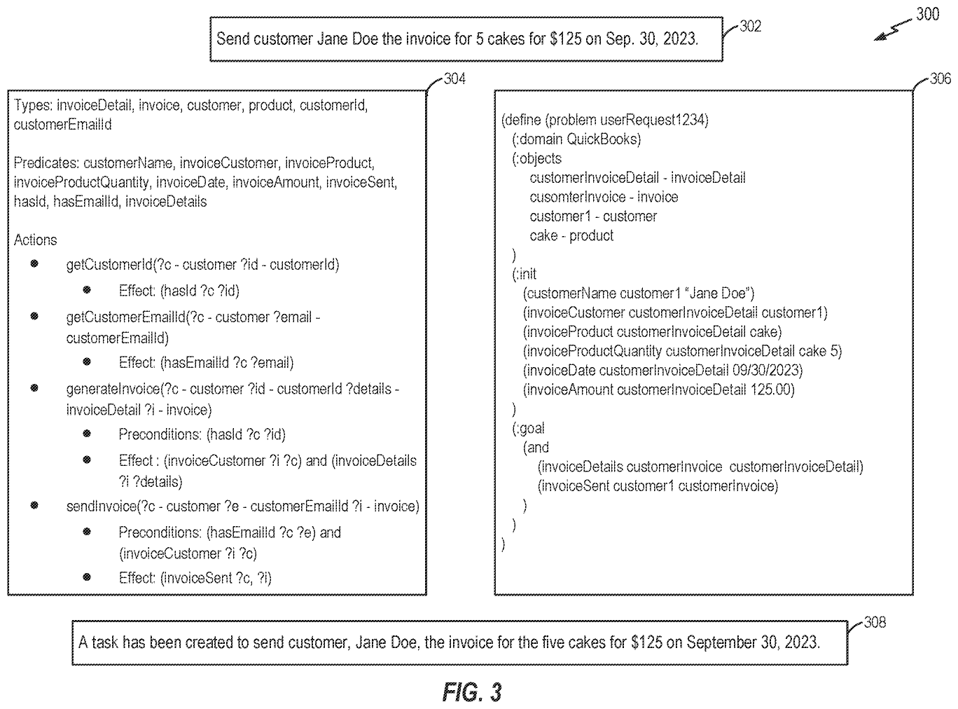

In some cases, workflow 200 is used to process and answer a prompt, such as prompt 302 depicted in FIG. 3. For example, workflow 200 may be used to answer prompt 302 by representing prompt 302 as a task description in PDDL 306. Task description in PDDL 306 may be generated based on prompt 302 and a pre-created domain description in PDDL 304. As such, FIGS. 2 and 3 are described in tandem below.

Workflow 200 begins with user 202 (e.g., similar to user 102 in FIG. 1) creating and submitting a prompt 204 to LLM 206. An example of prompt 204 may be prompt 302 in FIG. 3 requesting to “Send customer Jane Doe the invoice for 5 cakes for $125 on Sep. 30, 2023.” For this example, prompt 204 (e.g., example prompt 302) is an information-seeking and task-oriented prompt. For example, to resolve this query, contact information for customer Jane Doe, as well as information about the 5 cakes may need to be collected and then used when performing tasks such as generating and sending the invoice to customer Jane Doe.

Workflow 200 then proceeds with LLM 206 performing semantic analysis 226 to generate a representation of prompt 204 as prompt representation 228. Semantic analysis 226 refers to a process of understanding prompt 204 by extracting insightful information such as context, emotions, and/or sentiments from the unstructured data included in prompt 204. Performing semantic analysis 226 enables LLM 206 to understand, interpret, and/or derive meanings from prompt 204, which may be preserved in prompt representation 228. In other words, prompt representation 228 may include semantic features of prompt 204.

After the generation of prompt representation 228, workflow 200 proceeds with LLM 206 performing task description generation 232. Task description generation 232 includes generating a task description in PDDL 216 using prompt representation 228 and a domain description in the PDDL 230. For example, in FIG. 3, task description in PDDL 306 may be generated from domain description in PDDL 304 and a prompt representation generated for prompt 302. Domain description in PDDL 304 includes information about object types (e.g., shown as “Types”), predicates, and actions. Task description in PDDL 306 includes objects with their identified object type (e.g., from domain description in PDDL 304), an initial state (e.g., shown as “init”) determined from prompt 302, and a desired goal state (e.g., shown as “goal”), also determined from prompt 302. Here, the initial state includes information about Jane Doe as the customer, cake as the product needing to be invoiced, $125.00 as the amount that need to be invoiced, etc. all within a structured language and format that can be understood by planner 208 in FIG. 2. Further, the desired goal state includes information (also in the structured language and format that can be understood by planner 208 in FIG. 2) about needing invoice transmission, given prompt 302 was requesting that an invoice be sent to customer Jane Doe.

In some embodiments, task description generation 232 fails. For example, task description generation 232 may fail in cases where user 202 has not provided sufficient information to understand what the initial state is to generate task description in PDDL 216. In some cases, task description generation 232 fails if user 202 has not provided sufficient information to understand what user 202 desires by submitting the prompt. For example, a prompt 204 that recites “The cat is orange,” provides insufficient information about what user 202 attempts to achieve (e.g., information retrieval and/or other state change) by submitting prompt 204. In some cases, task description generation 232 fails if LLM 206 needs additional information from user 202. For example, if prompt 302 in FIG. 3 alternatively recited “Send customer the invoice,” LLM 206 may need additional about who the customer is, what the invoice is for, and/or when to send the invoice before being able to generate task description in PDDL 216. In some cases, task description generation 232 fails when a prompt 204 has sufficient information but violates one or more domain description constraints. For example, a prompt 204, submitted by a user 202 on Oct. 18, 2023, that recites “On Oct. 18, 2021, send customer Jane Doe a $540 invoice for the decorated cakes” may provide sufficient information about what user 202 attempts to achieve; however, the date indicated in prompt 204, of when to send the invoice, is in the past (e.g., two years prior). In some cases, task description generation 232 fails when a prompt 204 has sufficient information and clear intent (e.g., able to clearly discern the desired goal state of a user 202 that submitted prompt 204) but is outside the scope of a domain for the system receiving prompt 204. For example, a prompt 204, asking a medical question, received by a system able to handle financial related prompts may be outside the scope of a domain for the system.

Thus, at 234 in workflow 200, LLM 206 determines if task description generation 232 has failed for one or more reasons, and if task description generation 232 has failed, then workflow 200 proceeds to natural language failure response generation 235. At natural language failure response generation 235, a natural language response requesting additional information from user 202 may be generated such that task description generation 232 may be repeated. This natural language response may then be provided to user 202. Alternatively, if task description generation 232 has not failed and task description in PDDL 216 is generated, then workflow 200 proceeds to execution plan generation 236.

Execution plan generation 236 includes planner 208 generating an execution plan 218 for task description in PDDL 216. Execution plan 218 may be generated to include a sequence of steps used to transform the initial state to the desired goal state defined in task description in PDDL 216. Planner 208 may use domain description in PDDL 230 to determine actions that may be taken to reach the desired goal state, as well as their preconditions, if any. For the example in FIG. 3, planner 208 may determine that one of the steps that needs to be performed to reach the desired goal state is to send an invoice (e.g., perform action “(sendInvoice)” shown in domain description in PDDL 304 in FIG. 3). One precondition to sending an invoice is to have knowledge about an email ID of a recipient of the invoice such that the invoice can be sent (e.g., shown as “(hasEmailID?c?e) in domain description in PDDL 304 in FIG. 3). As such, planner 208 may determine to include another step prior to action “sendInvoice” which involves performing action “getCustomerEmailID” to obtain the email ID needed for sending the invoice.

Execution plan 218 generated by planner 208 may include a sequence of two or more steps, which planner 208 intends to be carried out in the order that they are presented in execution plan 218. The sequence of two or more steps may include steps for making API call(s) to one or more applications, initiating database query (ies) for one or more databases, triggering one or more functions (e.g., via one or more tools), and/or the like. The application(s), database(s), and/or tool(s) may be associated with/created for a specific organization (e.g., internal to a specific organization). Example steps included in execution plan 218 may include steps for executing a call to a database that includes information associated with a user, a product, a client, an organization, and/or the like, generating an invoice, sending an invoice, sending an email, updating information in a database, submitting a payment, accepting a payment, calculating an average, calculating a maximum, calculating a minimum, setting a reminder, etc.

In some embodiments, execution plan generation 236 further includes planner 208 making one or more conclusions based on data included in task description in PDDL 216. For example, a precondition of an action defined in domain description in PDDL 230 that planner determines is necessary for transforming to the desired goal state, may require that a customer be a resident of California. However, the task description in PDDL 216 may only indicate that the customer is a resident of San Diego. In this case, planner 208 may deduce that San Diego is a city in California, and thus determine that the precondition for the action is met such that this action can be added to execution plan 218. Planner 208 may make this type of conclusion, and/or other conclusions, based on predicates and rules defined in domain description in PDDL 230. For example, planner 208 may be able to deduce that the customer lives in California based on information in task description in PDDL 216 indicating that the customer lives in San Diego if the rule “lives (x, San Diego)=>lives (x, California)” is defined in domain description in PDDL 230.

In some embodiments, execution plan generation 236 fails. For example, execution plan generation 236 may fail in cases where one or more actions that are necessary to achieve the desired goal state are not available in the domain description in PDDL. In some cases, execution plan generation 236 fails where planner 208 determines task description in PDDL 216 is incomplete, and thus planner 208 is unable to generate execution plan 218. For example, if task description in PDDL 216 is generated without initial state information (e.g., shown as “init” in task description in PDDL 306 in FIG. 3), then planner 208 may not be able to perform execution plan generation 236 (e.g., execution plan generation fails).

Thus, at 238 in workflow 200, planner 208 determines if execution plan generation 236 has failed due to one or more errors in task description in PDDL 216, then workflow 200 returns to task description generation 232 to generate a new task description in PDDL to fix the one or more errors. Alternatively, if execution plan generation 236 has not failed and execution plan 218 is generated, then workflow 200 proceeds to plan execution 240.

Plan execution 240 is performed by execution component 210 to execute the sequence of steps included in execution plan 218. For example, execution component 210 may interface with tool(s) 242, application(s) 244 (e.g., via API(s)), and/or database(s) 246 to execute the sequence of steps.

In some embodiments, where the sequence of steps in execution plan 218 includes at least one step for making an API call to an application, executing the sequence of steps may include execution component 210 translating information included in execution plan 218 into one or more input parameters that are understood by the API. In other words, API parameters may be defined using different terminology than what is provided in execution plan 218. In some cases, such translation is performed using a mapping of parameters and actions in the domain description in PDDL to APIs and their corresponding parameters.

In some embodiments, plan execution 240 fails. For example, plan execution 240 may fail where execution component 210 identifies an outage of an API associated with at least one step in execution plan 218. In some cases, plan execution 240 fails where execution component 210 determines that one or more preconditions for at least one step in execution plan 218 have not been met at runtime. In some cases, plan execution 240 fails where execution component 210 receives a time out error or other error for a database query associated with at least one step in execution plan 218.

Thus, at 248 in workflow 200, execution component 210 determines if plan execution 240 has failed due to one or more errors, and if failure has occurred, then workflow 200 returns to execution plan generation 236 to generate a new execution plan 218. For example, if plan execution 240 fails due to an outage of an API, then a new execution plan may need to be generated at execution plan generation 236 which does not include a step involving the API that is determined to be down (e.g., assuming there are alternative methods, actions, APIs, etc. available that achieve the same goal). For example, if an execution plan 218 generated for a prompt 204 stating “How do I add a new employee to payroll?” includes an internal “Help API,” which is currently down, then a new execution plan may be generated at execution plan generation 236. The new execution plan may include a step to use two alternate APIs, such as a “Google Search API” and a “Summarization API,” in place of the internal “Help API.” On the other hand, if plan execution 240 has not failed, then execution output 220 may be generated and workflow 200 may proceed to natural language response generation 250.

As described above, execution output 220 is the structured representation of the answer, and/or all the information needed to generate a final answer to prompt 204. For example, execution output 220 may be the collective output of the APIs called during plan execution 240, which may be structured as JavaScript Object Notation (JSON) or extensible markup language (XML) (e.g., dependent upon the APIs). LLM 206 uses execution output 220 and prompt 204 to generate a natural language response 212 at natural language response generation 250. For example, both execution output 220 and prompt 204 may be used to generate natural language response 212 to help ensure that the response generated is relevant to prompt 204. Natural language response 212 is provided to user 202 as output from LLM 206 and in response to user 202 submitting prompt 204. For example, in FIG. 3, LLM 206 generates natural language response 308 reciting “The invoice for the five cakes for $125 was sent to Jane Doe today, Sep. 30, 2023.” This natural language response 308 is provided to the user that submitted prompt 302, in other words, requesting that the invoice be sent.

In some embodiments, LLM 206 is trained to generate natural language response 212 as a personalized response for user 202. For example, some users may prefer concise responses, while other users may prefer more detailed responses. Thus, when generating natural language response 212 for user 202, LLM 206 may take into consideration similar preferences of user 202. As another example, natural language response 212 may be personalized based on a profile (e.g., an age, a location, etc.) of user 202.

### Example Method for Prompt Processing

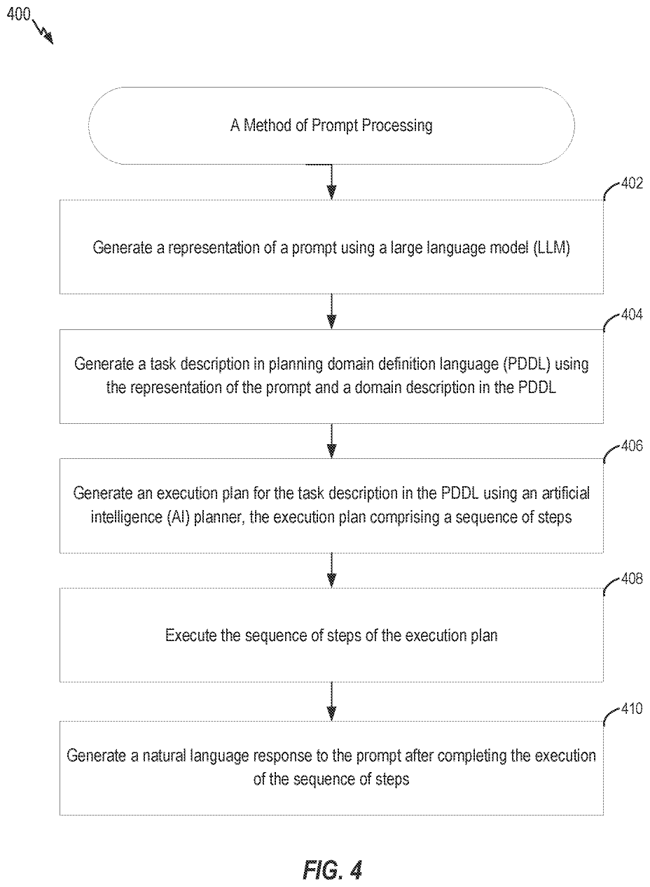

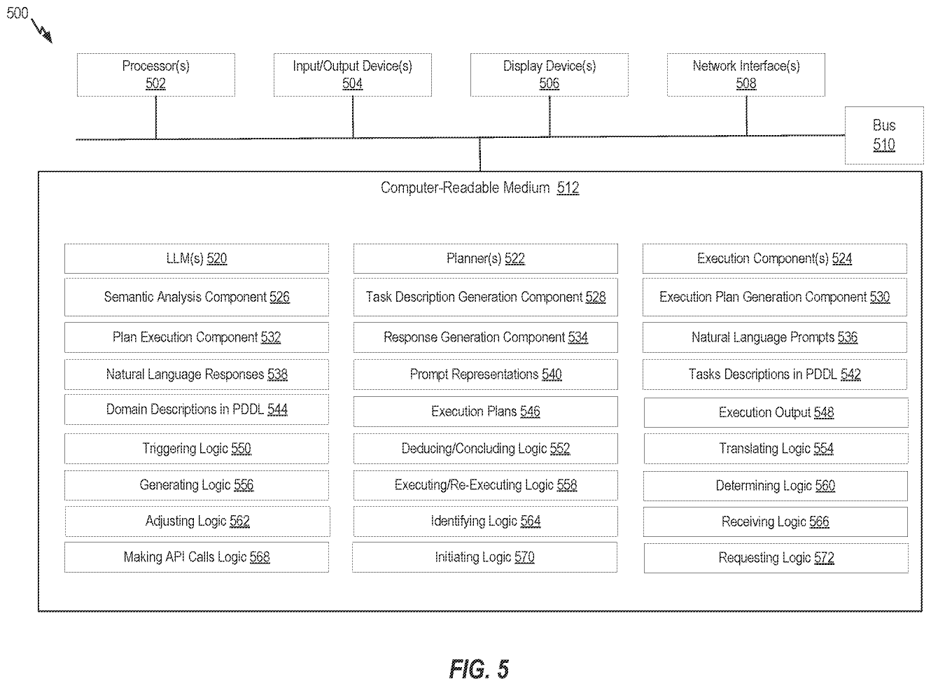

FIG. 4 depicts an example method for query processing. Method 400 may be performed by one or more processor(s) of a computing device, such as processor(s) 502 of processing system 500 described below with respect FIG. 5.

Method 400 begins, at step 402, with generating a representation of a prompt using an LLM. The generated representation may include semantic features of the prompt. The prompt may request a state change from an initial state to a desired goal state. In some embodiments, the desired goal state requested by the prompt comprises the completion of one or more tasks including information retrieval.

Method 400 proceeds, at step 404, with generating a task description in PDDL using the representation of the prompt and a domain description in the PDDL.

Method 400 proceeds, at step 406, with generating an execution plan for the task description in the PDDL using an AI planner. The execution plan may include a sequence of steps used to transform the initial state to the desired goal state.

In some embodiments, the sequence of steps include steps for at least one of: making one or more API calls to one or more applications; initiating one or more database queries for one or more databases; or triggering one or more functions.

In some embodiments, generating the execution plan at step 406 includes making one or more conclusions based on data included in the task description in the PDDL. At least one of the sequence of steps included in the execution plan may be associated with the one or more conclusions.

Method 400 proceeds, at step 408, with executing the sequence of steps of the execution plan.

In some embodiments, the sequence of steps includes at least one step for making an API call to an application, and executing the sequence of steps of the execution plan at step 408 includes translating information included the execution plan to one or more input parameters understood by the API.

Method 400 proceeds, at step 410, with generating a natural language response to the prompt after completing the execution of the sequence of steps. The natural language response may be based on the desired goal state.

In some embodiments, the natural language response is generated by the LLM, and the LLM is trained to generate the natural language response as a personalized response for a user associated with the prompt.

In some embodiments, method 400 further includes, during the execution of the sequence of steps at step 408, determining execution of at least one step of the sequence of steps has failed; adjusting the execution plan to create an adjusted execution plan and re-executing the adjusted execution plan. In some embodiments, determining the execution of the at least one step of the sequence of steps has failed includes identifying an outage of an application programming interface (API) associated with the at least one step; determining one or more preconditions for the at least one step have not been met; or receiving a time out error for a database query associated with the at least one step.

In some embodiments, method 400 further includes, prior to generating the execution plan at step 406, determining the generation of the task description in the PDDL has failed; and requesting, from a user that submitted the prompt, additional information for the prompt.

In some embodiments, method 400 further includes, prior to executing the sequence of steps at step 408, determining the generation of the execution plan for the task description in the PDDL has failed due to one or more errors associated with the task description in the PDDL and generating a new task description in the PDDL to fix the one or more errors.

In some embodiments, the desired goal state requested by the prompt comprises possession of information associated with at least one of a user, a product, a client, or an organization, the sequence of steps included in the execution plan comprises at least a call to a database comprising information associated with at least one of the user, the product, the client, or the organization, and the natural language response includes the information associated with at least one of the user, the product, the client, or the organization.

In some embodiments, the desired goal state requested by the prompt comprises the completion of one or more tasks, the one or more tasks excluding information retrieval, and the sequence of steps included in the execution plan to transform the initial state to the desired goal state comprises at least one step for: generating an invoice, sending an invoice, sending an email, updating information in a database, submitting a payment, accepting a payment, calculating an average, calculating a maximum, calculating a minimum, or setting a reminder.

Note that FIG. 4 is just one example of a method, and other methods including fewer, additional, or alternative steps are possible consistent with this disclosure.

### Example Processing System for Query Processing

FIG. 5 depicts an example processing system 500 configured to perform various aspects described herein, including, for example, method 400 as described above with respect to FIG. 4.

Processing system 500 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity.

Processor(s) 502 are generally configured to retrieve and execute instructions stored in one or more memories, including local memories like computer-readable medium 512, as well as remote memories and data stores. Similarly, processor(s) 502 are configured to store application data residing in local memories like the computer-readable medium 512, as well as remote memories and data stores. More generally, bus 510 is configured to transmit programming instructions and application data among the processor(s) 502, display device(s) 506, network interface(s) 508, and/or computer-readable medium 512. In certain embodiments, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various embodiments, display device(s) 516 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In this example, computer-readable medium 512 includes LLM(s) 520, planner(s) 522, execution component(s) 524, semantic analysis component 526, task description generation component 528, execution plan generation component 530, plan execution component 532, response generation component 534, natural language prompts 536, natural language responses 538, prompt representations 540, task descriptions in PDDL 542, domain descriptions in PDDL 544, execution plans 546, execution output 548, triggering logic 550, deducing/concluding logic 552, and translating logic 554, generating logic 556, executing/re-executing logic 558, determining logic 560, adjusting logic 562, identifying logic 564, receiving logic 566, making API calls logic 568, initiating logic 570, and requesting logic 572.

In some embodiments, triggering logic 550 includes logic for triggering one or more functions.

In some embodiments, deducing/concluding logic 552 includes logic for making one or more conclusions based on data included in the task description in the PDDL, wherein at least one of the sequence of steps included in the execution plan is associated with the one or more conclusions.

In some embodiments, translating logic 554 includes logic for translating information included the execution plan to one or more input parameters understood by the API.

In some embodiments, generating logic 556 includes logic for generating a representation of a prompt using an LLM. In some embodiments, generating logic 556 includes logic for generating a task description in PDDL based on using the representation of the prompt and a domain description in the PDDL. In some embodiments, generating logic 556 includes logic for generating an execution plan for the task description in the PDDL, the execution plan comprising a sequence of steps used to obtain the information or transform the initial state to the desired goal state. In some embodiments, generating logic 556 includes logic for generating a natural language response to the prompt after completing the execution of the sequence of steps, wherein the natural language response is based on the desired goal state. In some embodiments, generating logic 556 includes logic for generating a new task description in the PDDL to fix the one or more errors.

In some embodiments, executing/re-executing logic 558 includes logic for executing the sequence of steps of the execution plan. In some embodiments, executing/re-executing logic 558 includes logic for re-executing the adjusted execution plan.

In some embodiments, determining logic 560 includes logic for determining execution of at least one step of the sequence of steps has failed. In some embodiments, determining logic 560 includes logic for determining one or more preconditions for the at least one step have not been met at runtime. In some embodiments, determining logic 560 includes logic for determining the generation of the task description in the PDDL has failed. In some embodiments, determining logic 560 includes logic for determining the generation of the execution plan for the task description in the PDDL has failed due to one or more errors associated with the task description in the PDDL.

In some embodiments, adjusting logic 562 includes logic for adjusting the execution plan to create an adjusted execution plan.

In some embodiments, identifying logic 564 includes logic for identifying an outage or an error when invoking an API associated with the at least one step.

In some embodiments, receiving logic 566 includes logic for receiving a time out error or other error for a database query associated with the at least one step.

In some embodiments, making API calls logic 568 includes logic for making one or more API calls to one or more applications.

In some embodiments, initiating logic 570 includes logic for initiating one or more database queries for one or more databases.

In some embodiments, requesting logic 572 includes logic for requesting, from a user that submitted the prompt, additional information for the prompt.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of prompt processing, comprising: generating a representation of a prompt using a large language model (LLM), the representation comprising semantic features of the prompt, wherein the prompt requests a state change from an initial state to a desired goal state; generating a task description in planning domain definition language (PDDL) using the representation of the prompt and a domain description in the PDDL; generating an execution plan for the task description in the PDDL, the execution plan comprising a sequence of steps used to transform the initial state to the desired goal state; executing the sequence of steps of the execution plan; and generating a natural language response to the prompt after completing the execution of the sequence of steps, wherein the natural language response is based on the desired goal state.

Clause 2: The method of Clause 1, further comprising, during the execution of the sequence of steps: determining execution of at least one step of the sequence of steps has failed; adjusting the execution plan to create an adjusted execution plan; and re-executing the adjusted execution plan.

Clause 3: The method of Clause 2, wherein determining the execution of the at least one step of the sequence of steps has failed comprises: identifying an outage or an error when invoking an application programming interface (API) associated with the at least one step; determining one or more preconditions for the at least one step have not been met at runtime; or receiving a time out error or other error for a database query associated with the at least one step.

Clause 4: The method of any one of Clauses 1-3, further comprising, prior to generating the execution plan: determining the generation of the task description in the PDDL has failed; and requesting, from a user that submitted the prompt, additional information for the prompt.

Clause 5: The method of any one of Clauses 1-4, further comprising, prior to executing the sequence of steps: determining the generation of the execution plan for the task description in the PDDL has failed due to one or more errors associated with the task description in the PDDL; and generating a new task description in the PDDL to fix the one or more errors.

Clause 6: The method of any one of Clauses 1-5, wherein: the sequence of steps comprises at least one step for making an application programming interface (API) call to an application, and executing the sequence of steps of the execution plan comprises translating information included the execution plan to one or more input parameters understood by the API.

Clause 7: The method of any one of Clauses 1-6, wherein the sequence of steps comprise steps for at least one of: making one or more application programming interface (API) calls to one or more applications; initiating one or more database queries for one or more databases; or triggering one or more functions.

Clause 8: The method of any one of Clauses 1-7, wherein generating the execution plan for the task description in the PDDL comprises making one or more conclusions based on data included in the task description in the PDDL, wherein at least one of the sequence of steps included in the execution plan is associated with the one or more conclusions.

Clause 9: The method of any one of Clauses 1-8, wherein: the natural language response is generated by the LLM, and the LLM is trained to generate the natural language response as a personalized response for a user associated with the prompt.

Clause 10: The method of any one of Clauses 1-9, wherein: the desired goal state requested by the prompt comprises possession of information associated with at least one of a user, a product, a client, or an organization, the sequence of steps included in the execution plan comprises at least a call to a database comprising information associated with at least one of the user, the product, the client, or the organization, and the natural language response comprises the information associated with at least one of the user, the product, the client, or the organization.

Clause 11: The method of any one of Clauses 1-10, wherein: the desired goal state requested by the prompt comprises the completion of one or more tasks, the one or more tasks excluding information retrieval, and the sequence of steps included in the execution plan to transform the initial state to the desired goal state comprises at least one step for: generating an invoice, sending an invoice, sending an email, updating information in a database, submitting a payment, accepting a payment, calculating an average, calculating a maximum, calculating a minimum, or setting a reminder.

Clause 12: The method of any one of Clauses 1-11, wherein the desired goal state requested by the prompt comprises the completion of one or more tasks including information retrieval.

Clause 13: A processing system, comprising: a memory comprising computer-executable instructions; and a processor configured to execute the computer-executable instructions and cause the processing system to perform a method in accordance with any one of Clauses 1-12.

Clause 14: A processing system, comprising means for performing a method in accordance with any one of Clauses 1-12.

Clause 15: A non-transitory computer-readable medium storing program code for causing a processing system to perform the steps of any one of Clauses 1-12.

Clause 16: A computer program product embodied on a computer-readable storage medium comprising code for performing a method in accordance with any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of prompt processing, comprising:
generating a representation of a prompt using a large language model (LLM), the representation comprising semantic features of the prompt, wherein the prompt requests a state change from an initial state to a desired goal state;
generating a task description in planning domain definition language (PDDL) using the representation of the prompt and a domain description in the PDDL;
generating an execution plan for the task description in the PDDL using an artificial intelligence (AI) planner, the execution plan comprising a sequence of steps used to transform the initial state to the desired goal state;
executing the sequence of steps of the execution plan; and
generating a natural language response to the prompt after completing the execution of the sequence of steps, wherein the natural language response is based on the desired goal state.

2. The method of claim 1, further comprising, during the execution of the sequence of steps:
determining execution of at least one step of the sequence of steps has failed;
adjusting the execution plan to create an adjusted execution plan; and
re-executing the adjusted execution plan.

3. The method of claim 2, wherein determining the execution of the at least one step of the sequence of steps has failed comprises:
identifying an outage or an error when invoking an application programming interface (API) associated with the at least one step;
determining one or more preconditions for the at least one step have not been met at runtime; or
receiving a time out error or other error for a database query associated with the at least one step.

4. The method of claim 1, further comprising, prior to generating the execution plan:
determining the generation of the task description in the PDDL has failed; and
requesting, from a user that submitted the prompt, additional information for the prompt.

5. The method of claim 1, further comprising, prior to executing the sequence of steps:
determining the generation of the execution plan for the task description in the PDDL has failed due to one or more errors associated with the task description in the PDDL; and
generating a new task description in the PDDL to fix the one or more errors.

6. The method of claim 1, wherein:
the sequence of steps comprises at least one step for making an application programming interface (API) call to an application, and
executing the sequence of steps of the execution plan comprises translating information included in the execution plan to one or more input parameters understood by the API.

7. The method of claim 1, wherein the sequence of steps comprise steps for at least one of:
making one or more application programming interface (API) calls to one or more applications;
initiating one or more database queries for one or more databases; or
triggering one or more functions.

8. The method of claim 1, wherein generating the execution plan for the task description in the PDDL comprises making one or more conclusions based on data included in the task description in the PDDL, wherein at least one of the sequence of steps included in the execution plan is associated with the one or more conclusions.

9. The method of claim 1, wherein:
the natural language response is generated by the LLM, and
the LLM is trained to generate the natural language response as a personalized response for a user associated with the prompt.

10. The method of claim 1, wherein:
the desired goal state requested by the prompt comprises possession of information associated with at least one of a user, a product, a client, or an organization,
the sequence of steps included in the execution plan comprises at least a call to a database comprising the information associated with at least one of the user, the product, the client, or the organization, and
the natural language response comprises the information associated with at least one of the user, the product, the client, or the organization.

11. The method of claim 1, wherein:
the desired goal state requested by the prompt comprises a completion of one or more tasks, the one or more tasks excluding information retrieval, and
the sequence of steps included in the execution plan to transform the initial state to the desired goal state comprises at least one step for:
generating an invoice,
sending an invoice,
sending an email,
updating information in a database,
submitting a payment,
accepting a payment,
calculating an average,
calculating a maximum,
calculating a minimum, or
setting a reminder.

12. The method of claim 1, wherein the desired goal state requested by the prompt comprises a completion of one or more tasks including information retrieval.

13. An apparatus, comprising:
one or more memories comprising processor-executable instructions;
and one or more processors configured to execute the processor-executable instructions and cause the apparatus to:
generate a representation of a prompt using a large language model (LLM), the representation comprising semantic features of the prompt, wherein the prompt requests a state change from an initial state to a desired goal state;
generate a task description in planning domain definition language (PDDL) using the representation of the prompt and a domain description in the PDDL;
generate an execution plan for the task description in the PDDL using an artificial intelligence (AI) planner, the execution plan comprising a sequence of steps used to transform the initial state to the desired goal state;
execute the sequence of steps of the execution plan; and
generate a natural language response to the prompt after completing the execution of the sequence of steps, wherein the natural language response is based on the desired goal state.

14. The apparatus of claim 13, wherein the one or more processors are configured to execute the processor-executable instructions and further cause the apparatus to, during the execution of the sequence of steps:
determine execution of at least one step of the sequence of steps has failed;
adjust the execution plan to create an adjusted execution plan; and
re-execute the adjusted execution plan.

15. The apparatus of claim 14, wherein to determine the execution of the at least one step of the sequence of steps has failed, the one or more processors are configured to:
identify an outage or an error when invoking an application programming interface (API) associated with the at least one step;
determine one or more preconditions for the at least one step have not been met at runtime; or
receive a time out error or other error for a database query associated with the at least one step.

16. The apparatus of claim 13, wherein the one or more processors are configured to execute the processor-executable instructions and further cause the apparatus to, prior to generating the execution plan:
determine the generation of the task description in the PDDL has failed; and
request, from a user that submitted the prompt, additional information for the prompt.

17. The apparatus of claim 13, wherein the one or more processors are configured to execute the processor-executable instructions and further cause the apparatus to, prior to executing the sequence of steps:
determine the generation of the execution plan for the task description in the PDDL has failed due to one or more errors associated with the task description in the PDDL; and
generate a new task description in the PDDL to fix the one or more errors.

18. The apparatus of claim 13, wherein:
the sequence of steps comprises at least one step for making an application programming interface (API) call to an application, and
to execute the sequence of steps of the execution plan, the one or more processors are configured to translate information included in the execution plan to one or more input parameters understood by the API.

19. The apparatus of claim 13, wherein the sequence of steps comprise steps for at least one of:
making one or more application programming interface (API) calls to one or more applications;
initiating one or more database queries for one or more databases; or
triggering one or more functions.

20. The apparatus of claim 13, wherein to generate the execution plan for the task description in the PDDL, the one or more processors are configured to make one or more conclusions based on data included in the task description in the PDDL, wherein at least one of the sequence of steps included in the execution plan is associated with the one or more conclusions.
